(19) United States
(12) Patent Application Publication
(10) Pub. No.: US 2006/0280833 A1
(43) Pub. Date: Dec. 14, 2006

(54) Injection-molding machine

(75) Inventor: Volker Krell, Neuhausen (DE)

Correspondence Address: WILLIAM COLLARD;COLLARD & ROE, P.C., 1077 NORTHERN BOULEVARD, ROSLYN, NY, 11576, US

(73) Assignee: Klockner Desma Elastomertechnik GmbH

(21) Appl. No.: 11/406,928

(22) Filed: Apr. 19, 2006

(30) Foreign Application Priority Data
Jun. 10, 2005 (DE) 10 2005 026.850.1

(51) Int. Cl. B29C 45/66

(52) U.S. Cl. 425/589

(57) ABSTRACT

An injection-molding machine has a fixed mold clamping plate and a mold backing plate that can be moved relative to the fixed plate. The movable backing plate can be moved relative to the fixed backing plate, guided along columns or plungers, by means of a process drive. Mold halves held on the backing plates are disposed outside of the space delimited by the columns/plungers. One of the mold backing plates has accommodation spaces for the column ends that are moving in. The spaces are connected with one another and form a system that is closed in itself and filled with a pressure agent, to which pressure can be applied. Each column on the mold side carries a piston-shaped cap on the face of the cap that points into the accommodation space, in each instance, which is larger in diameter, passes completely through the accommodation space, and projects out of it, forming a seal.

### CROSS REFERENCE TO RELATED APPLICATIONS

Applicant claims priority under 35 U.S.C. §119 of German Application No. 10 2005 026 850.1 filed Jun. 10, 2005.

### BACKGROUND OF THE INVENTION

1. Field of the Invention

The present invention relates to an injection-molding machine having a fixed mold clamping plate and a mold backing plate that can be moved relative to the fixed mold clamping plate. More particularly, the invention relates to an injection-molding machine in which the movable backing plate can be moved relative to the fixed backing plate, guided along columns, by means of a process drive.

2. The Prior Art

Injection-molding machines serve for the production of injection-molded parts made of plastic and/or elastomers. In the case of vertical machines, the mold backing plates are disposed on top of one another, and in the case of horizontal machines, they are disposed next to one another. As a rule, the two mold halves are situated on the mold backing plates within the space delimited by the columns.

After the mold parts have been moved together by means of the process drive, a strong mold closing force must be applied, so that no material can exit from the mold halves during the injection-molding process. The forces that occur in this connection deform the mold backing plates, thereby impairing the parallelity of the two mold halves relative to one another and therefore of the mold halves.

In the case of the geometries just cited, this non-parallelity is not so serious, because of the symmetry of the introduction of the force. However, access to the shaping mold by a machine operator for emptying the mold after the injection-molding process is difficult.

If the mold halves were to be disposed outside the area delimited by the columns, however, the application of the closing force to the mold halves would result in a significant asymmetry of the forces. This asymmetry in turn results in undesirable moments within the system formed by the mold backing plates and the columns, so that bending of the plates and the columns occurs and, of course, non-parallelity occurs within the mold.

### SUMMARY OF THE INVENTION

It is therefore an object of the present invention to provide an injection-molding machine in which the mold halves are not disposed within the area delimited by the columns, but rather outside of it, so that the person operating the machine can have easier access to the shaping mold and can empty it easily after the injection-molding process, and in which the undesirable torques and forces that occur during the closing process and as the closing force is applied are balanced out so that precise parallelity of the mold backing plates and therefore of the mold halves is achieved.

These and other objects are accomplished, according to the invention, by providing an injection-molding machine in which one of the mold backing plates has accommodation spaces for the column ends that are moving in. The spaces are connected with one another and form a system that is closed in itself and filled with a pressure agent, to which pressure can be applied. The column(s) on the mold side carry/carries a piston-like cap on its/their face(s) that point(s) into the accommodation space, in each instance, which is larger in diameter, passes completely through the accommodation space, and projects out of it, forming a seal.

In the open state, the faces of the columns end with the underside of the accommodation spaces, whereby the piston-like cap(s) sit(s) on the underside of the accommodation space(s), pass(es) through the entire accommodation space, and project(s) out of the accommodation space at its other end, in sealed manner.

The system formed by the accommodation spaces is filled with a pressure agent. If the movable mold backing plate is now moved towards the fixed backing plate by means of the process drive, the columns penetrate into the accommodation space, in each instance. In this connection, the at least one column away from the mold side displaces pressure agent out of the accommodation space assigned to it, which agent flows into the accommodation space on the mold side, practically without pressure, by way of the connection.

As soon as the mold halves are in contact with one another, pressure is applied to the system. The pressure agent exerts a pressure force on the at least one plunger that forms a piston, away from the mold side, while a tensile force is exerted on the column assigned to the piston-like cap, by means of the pressure applied to it, causing the forces and torques to cancel one another out and guaranteeing good parallelity of the mold backing plates, i.e. of the mold halves.

Because of the larger diameter of the piston-like cap, the accommodation spaces assigned to them are configured to be larger in volume than the two other accommodation spaces, into which the columns configured without caps move.

Because more oil is used up during the closing process on the side of the accommodation space having the larger volume than in the other accommodation space, according to one embodiment, the closed system is connected with a pressure agent reservoir, by way of a valve, from which reservoir pressure agent can additionally flow in through the suction valve. This pressure agent is passed back to the reservoir by way of the valve when the mold is opened.

In another embodiment, a pressure agent cylinder is disposed in at least one of the piston-like caps as a process drive, the piston rod of which projects out of the cap and engages with a yoke that is attached to the backing plate and bridges the cap end in portal-like manner.

Because this pressure agent cylinder is responsible only for moving the mold backing plate with the mold half that is attached to it, the cylinder can be dimensioned to be quite small. Thus, the mold backing plate, pressure spaces, suction tank, and process drive are implemented as an integrated component.

By means of the geometry and placement of the few individual parts, a parallel introduction of force is automatically set according to the invention. Specifically, by using cylindrical elements for generating the force (tensile force at one time, pressure force at another), forces and torques cancel one another out under closing force.

The closed system mentioned above is preferably disposed within the movable backing plate, whereby according to a further embodiment, the two mold backing plates are disposed vertically on top of one another, and the movable backing plate with the closed system represents the upper yoke of the machine.

Likewise possible, however, is an implementation of the invention in the case of a horizontal machine, whereby the mold backing plates are disposed horizontally, parallel to one another.

To monitor the parallelity of the mold halves relative to one another, in a further embodiment a sensor device is provided between the backing plates (particularly within the space delimited by the columns), in order to detect any possible deformations of same.

According to a further embodiment, this sensor device preferably is made up of a laser light source disposed on a mold backing plate. The laser light from the source falls on either a receiver that is disposed on the opposite mold backing plate, or on a reflector disposed there, which throws the laser light beam back to the laser light source, in which a receiver is disposed.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a schematic representation of a vertical injection-molding machine in the open state.

FIG. 2 shows the machine according to FIG. 1 in the closed state.

### DETAILED DESCRIPTION OF PREFERRED EMBODIMENTS

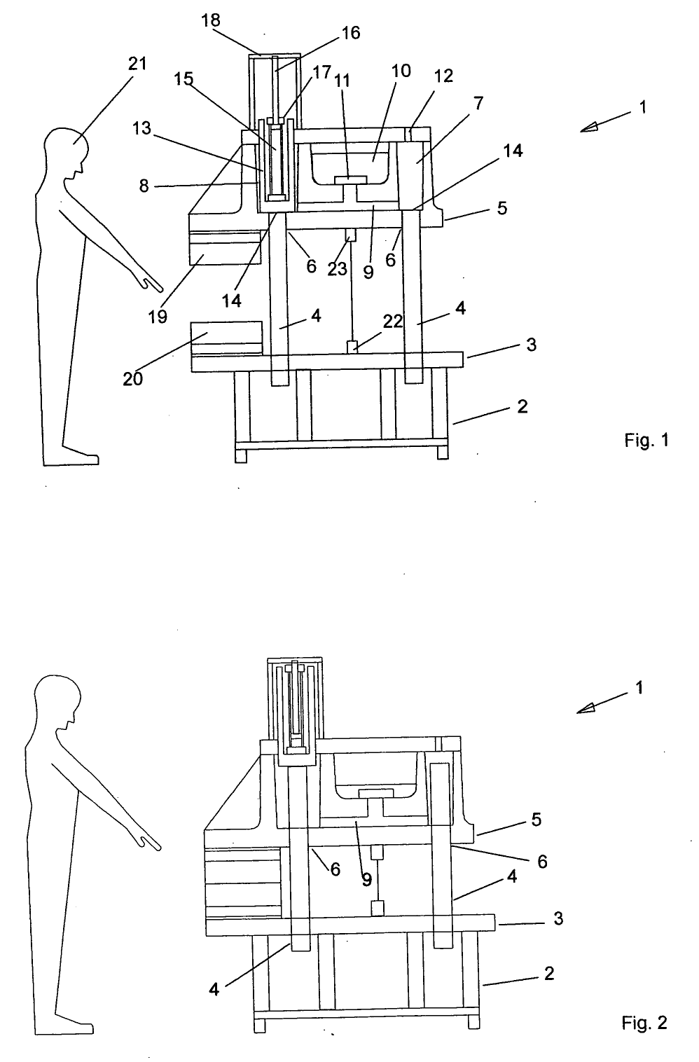

Turning now in detail to the drawings, FIGS. 1 and 2 show schematically a vertical injection-molding machine designated, in general, with the reference symbol 1. The essential components of machine 1 are the machine bed 2, a fixed lower mold backing plate 3 disposed on this machine bed, in which plungers or columns 4 are fixed vertically. A mold backing plate 5 is disposed opposite fixed mold backing plate 3, disposed to move on these columns 4.

In movable mold backing plate 5, passage openings 6 are provided for the free ends of the columns 4. Above passage openings 6, approximately cylindrical accommodation spaces 7 and 8, respectively, are provided in the mold backing plate, which spaces are connected with one another by way of a channel 9.

In the present example, a pressure agent reservoir 10 is disposed between accommodation spaces 7 and 8, above the connection channel 9, which reservoir is connected with connection channel 9 by way of a valve 11.

Accommodation spaces 7 and 8, connection channel 9, and the pressure agent reservoir 10 form a system that is closed in itself and filled with pressure agent. Furthermore, in the present example, a feed line 12 is provided in accommodation space 7, by way of which pressure can be applied to the system formed by accommodation spaces 7, 8, and connection channel 9 from the outside.

A cap 13 configured as a piston is set onto the columns 4 that reach into the accommodation spaces, i.e. accommodation space 8. Cap 13 is larger in diameter than the column 4 that carries it. The upper ends 14 of columns 4 end approximately with the undersides of accommodation spaces 7, 8 in the open state (FIG. 1) of the machine. Accommodation space 7 is closed off towards the top (except for the pressure agent feed line 12).

Accommodation space 8 is closed off towards the top by means of the piston-like cap 13, since this cap 13 projects out of the accommodation space 8 towards the top, in sealed manner.

A pressure agent cylinder 15 is disposed within piston-like cap 13, the piston rod 16 of which is attached to a yoke 18 that spans the cap opening 17 in portal-like manner.

When piston rod 16 is moved into cylinder 15, mold backing plate 5 moves down towards fixed mold backing plate 3, whereby the two mold halves 19, 20 are guided towards one another. Mold halves 19 and 20 are disposed on mold backing plates 3 and 5, outside of the space delimited by columns 4, so that the operator 21 can easily get at the shaping mold halves 19, 20, without any risk.

When mold backing plate 5 moves down towards fixed mold backing plate 3, columns 4 move into accommodation spaces 7 and 8, respectively, that are assigned to them, with their ends 14. In this process, column 4 displaces pressure agent in accommodation space 7, which agent flows practically without pressure through channel 9, into accommodation space 8, in which piston-like cap 13 releases the corresponding space. In addition, oil also flows out of reservoir 10 as replenishment. This situation is shown in FIG. 2.

Once the two mold halves 19 and 20 have moved onto one another, pressure is applied to the system formed by accommodation spaces 7, 8, and connection channel 9 from the outside, by way of feed line 12. In this way, a pressure force is exerted on the column 4 in accommodation space 7, and a tensile force is exerted on the column 4 in accommodation space 8, because of the pressure effect on piston-like cap 13. Examples of numbers to be mentioned here are 670 kN as the effective tensile force, while the pressure force on the other side is approximately 196 kN.

Because of the geometry of accommodation spaces 7, 8 and the configuration of columns 4 and piston-like caps 13, as well as because of the distance from the center point of the mold, mutual cancellation of the forces, i.e. moments takes place, thereby maintaining the mold shut parallel.

To monitor the parallelity of mold backing plates 3 and 5, i.e. the mold parallelity, a sensor system is provided between mold backing plates 3 and 5. This sensor system is made up of, in the present example, of a laser light source (in this case on lower mold backing plate 3) and a receiver, i.e. reflector 23 disposed on the opposite mold backing plate 5.

If the parallelity of plates 3, 5, i.e. of the mold halves 19, 20 is disrupted, receiver 23 would not detect the full light intensity, because of the plate deformation, so that a signal would be generated to shut off the machine.

Although at least one embodiment has been shown and described, it is to be understood that many changes and modifications may be made thereunto without departing from the spirit and scope of the invention as defined in the appended claims.

What is claimed is:

1. An injection-molding machine comprising:
(a) a fixed mold backing plate;
(b) a movable mold backing plate movable relative to said fixed mold backing plate;
(c) a plurality of columns for guiding said movable mold backing plate, each column having a column end, said plurality of columns comprising at least one column on a mold side;
(d) a process drive for moving said movable mold backing plate;
(e) a first mold half held on said fixed mold backing plate; and
(f) a second mold half held on said movable mold backing plate;
wherein said columns define a space and the first and second mold halves are disposed outside said space;
wherein one of said backing plates has a plurality of interconnected accommodation spaces for receipt of the column ends, said interconnected accommodation spaces forming a pressurizable closed system filled with a pressure agent, said at least one column on the mold side carrying a piston-shaped cap on a face of said at least one column pointing into a respective accommodation space larger in diameter than said piston-shaped cap, said piston-shaped cap passing completely through and projecting out of the accommodation space to form a seal.

2. The injection-molding machine according to claim 1, wherein the first and second mold halves form a mold and said accommodation spaces comprise a first accommodation space on the mold side and a second accommodation space on a side away from the mold, the first accommodation space having a larger volume than the second accommodation space.

3. The injection-molding machine according to claim 1, further comprising a pressure agent reservoir and a valve, the closed system being connected with the pressure agent reservoir via the valve.

4. The injection-molding machine according to claim 1, further comprising a yoke attached to one of the backing plates, wherein said process drive comprises a pressure agent cylinder disposed in at least one of the piston-shaped caps, said pressure agent cylinder comprising a piston rod projecting out of the cap, engaging with the yoke, and bridging a cap end of the cap.

5. The injection-molding machine according to claim 1, wherein the closed system is disposed within the movable mold backing plate.

6. The injection-molding machine according to claim 1, further comprising a sensor device provided between the backing plates to monitor parallelity of the backing plates.

7. The injection-molding machine according to claim 6, wherein the sensor device comprises a laser light source and a receiver.

8. The injection-molding machine according to claim 7, further comprising a reflector for reflecting light from the laser light source onto the receiver.

9. The injection-molding machine according to claim 1, wherein the backing plates are disposed vertically on top of one another.

10. The injection-molding machine according to claim 1, wherein the backing plates are disposed horizontally next to one another.
